(19) United States
(12) Patent Application Publication
(10) Pub. No.: US 2011/0194466 A1
(43) Pub. Date: Aug. 11, 2011

(54) Pull Based Data Driven Consultative Transfer

(75) Inventors: Ajit Kalele, Bellevue, WA (US); Rajesh Ramanathan, Redmond, WA (US)

(73) Assignee: MICROSOFT CORPORATION, Redmond, WA (US)

(21) Appl. No.: 12/701,950

(22) Filed: Feb. 8, 2010

(51) Int. Cl. H04L 12/16; H04L 12/66; H04M 3/42

(52) U.S. Cl. 370/261; 370/352; 379/212.01

(57) ABSTRACT

A method for transferring a telephone call includes receiving a communication at a first client computer from a second client computer. The first client computer and the second client computer run communication software that supports voice over Internet Protocol. The communication includes a request to transfer the telephone call to the first client computer. After receiving the communication from the second client computer at the first client computer, determining whether to accept the telephone call. When a determination is made to accept the telephone call, an action is initiated at the first client computer that causes the telephone call to be transferred to the first client computer. The action results in replacing the second client computer with the first client computer as a party in the telephone call.

### BACKGROUND

Voice over IP (VOIP) is a technology that permits the delivery of voice communications over networks implementing the Internet Protocol (IP), such as the Internet. A VOIP network includes a plurality of client computers running software that supports VOIP. Voice connections can be created between client computers. Other devices, for example landline or mobile telephones, can be connected to the VOIP network using a gateway.

One way in which voice connections can be transferred from one device to another is by using a consultation call. In a consultation call, one party in the telephone call, a first party, calls a second party to determine whether the second party wishes to accept the call. If the second party indicates to the first party that the second party is willing to accept the call, the first party typically initiates some action, such as pressing a transfer button, to transfer the call to the second party.

### SUMMARY

One aspect relates to a method for transferring a telephone call, the method including: receiving a communication at a first client computer from a second client computer. The first client computer and the second client computer run communication software that supports voice over Internet Protocol. The communication includes information associated with a telephone call received at the second client computer. The information includes a request to transfer the telephone call to the first client computer. After receiving the communication from the second client computer at the first client computer, a determination is made whether to accept the telephone call. When a determination is made to accept the telephone call, an action is initiated at the first client computer that causes the telephone call to be transferred to the first client computer. The action results in replacing the second client computer with the first client computer as a party in the telephone call.

Another aspect includes a first electronic computing device that is configured to run a communications application. The first electronic computing device including a computer readable storage medium, and a processing unit that executes computer readable instructions stored on the computer readable storage medium. The processing unit creates a user interface module that controls a user interface at the first electronic device and a business logic module implementing communication functions for the communications application. The communication functions include processing signaling information received as part of a communication from a second electronic computing device. The signaling information includes information about a telephone call received at the second electronic computing device. The business logic module permits a user at the first electronic computing device to replace the second electronic computing device with the first electronic computing device in the telephone call.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports direct consultation call transfer across nodes in a VOIP network.

FIG. 2 shows action flow in an example direct consultation call transfer using the system of FIG. 1.

FIG. 3 shows action flow in another example direct consultation call transfer using the system of FIG. 1.

FIG. 4 shows example modules of an example client computer of FIG. 1.

FIG. 5 shows an example user interface of an example client computer of the system of FIG. 1.

FIG. 6 shows a flowchart of a method for using a consultation call or instant message to transfer a telephone call directly.

FIG. 7 shows a flowchart of a method for using a consultation call or instant message to initiate a conference call directly.

FIG. 8 shows example components of the client computer of FIG. 4.

### DETAILED DESCRIPTION

The present application is directed to systems and methods for using a pull based, data driven call transfer mechanism to directly transfer a telephone call from a first party to a second party.

A consultation call is a telephone call in which a person that wishes to transfer a call calls the person to whom the call is to be transferred to determine whether that person is willing to accept the call. In one example, the person to whom the call is to be transferred is a manager or supervisor, commonly known as a boss. In this example, the person who initiates the consultation call is an assistant or delegate of the boss. The consultation call can be initiated from a telephone on the public switched telephone network (PSTN) or from a client computer running VOIP software on a VOIP network.

In a VOIP network, voice information is converted into packets of information that are sent between nodes in the network. The nodes typically include client computers, server computers, routers and gateways. Each packet of information is sent as part of a message that is sent between nodes in the network. For example, a client computer that initiates a consultation telephone call (typically a delegate) is one node and a client computer that receives the consultation call (typically a boss) is a second node. A client computer that initiates a telephone call to the delegate is a third node.

In an example, a telephone call is established between a first party and a delegate. The first party may be a user of a client computer on a VOIP network or may be a caller from a landline or a mobile telephone. When the first party indicates to the delegate that the first party would like to speak to the delegate's boss, the delegate initiates a communication with the boss. The communication may be a consultation call, wherein the delegate speaks to the boss or the communication may be an instant message or email from the delegate to the boss. Other means of communication are possible.

The communication includes identification information that indicates to the boss the identity of the first party and may also include additional information such as the purpose of the telephone call. Using the systems and methods described in the present application, the boss makes a determination whether or not to accept the telephone call and then initiates an action to connect to the first party without any additional action being taken by the delegate. The action is considered a pull based action because the boss and not the delegate is initiating the action. In addition, the action is data driven because it is based on information included in the communication.

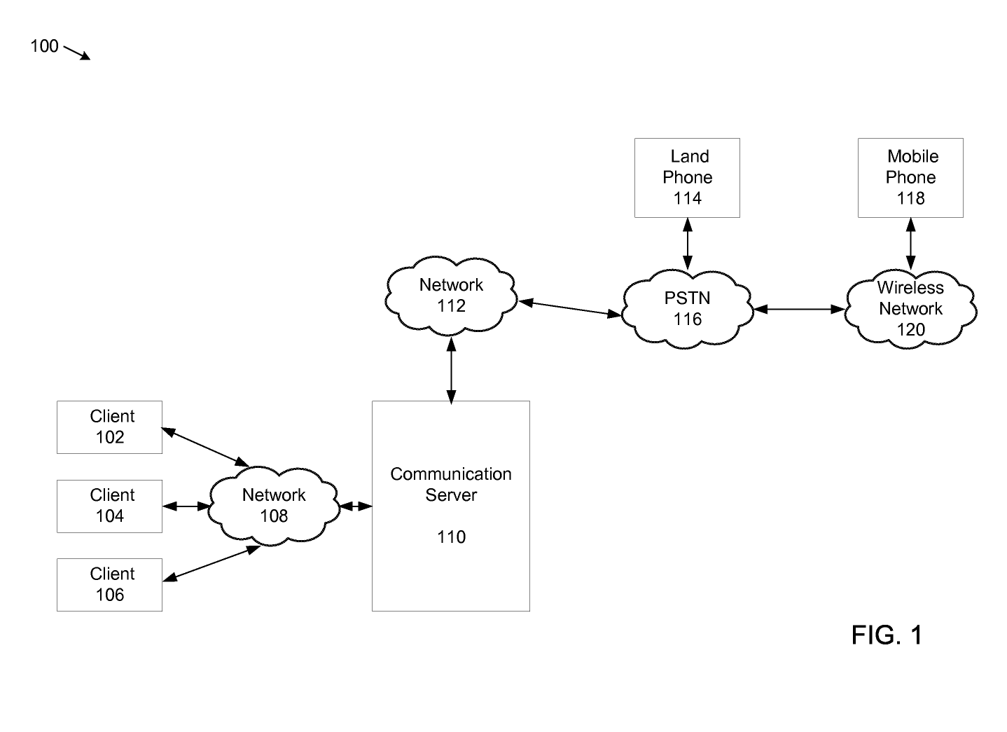

FIG. 1 shows an example system 100 that supports direct consultation call transfer across nodes in a VOIP network. The example system 100 includes client computers 102, 104, 106, network 108, communication server 110, network 112, land telephone 114, public switched telephone network (PSTN) 116, mobile telephone 118 and wireless network 120.

The example client computers 102, 104, 106 have a software program installed that supports VOIP communication. One example software program is Microsoft Office Communicator from Microsoft Corporation of Redmond, Wash. The example communication server 110 provides the infrastructure to support VOIP, instant messaging, video conferencing and other communication services. An example communication server is Microsoft Office Communications Server 2007 from Microsoft Corporation of Redmond Wash. Network 108 is typically a corporate network such as a company Intranet. Network 112 is a wide area network such as the Internet. More or fewer client computers, communication servers, land telephones, mobile telephones and networks can be used.

In the example system 100, calls initiated from client computers 102, 104, 106 or calls received at client computers 102, 104, 106 are sent to/from these client computers via communication server 110. In a VOIP network, the calls comprise messages that are transmitted according to a communication protocol. A common communication protocol used in VOIP networks is the Session Initiation Protocol (SIP), described in RFCs 3261, 3515 and other related RFCs.

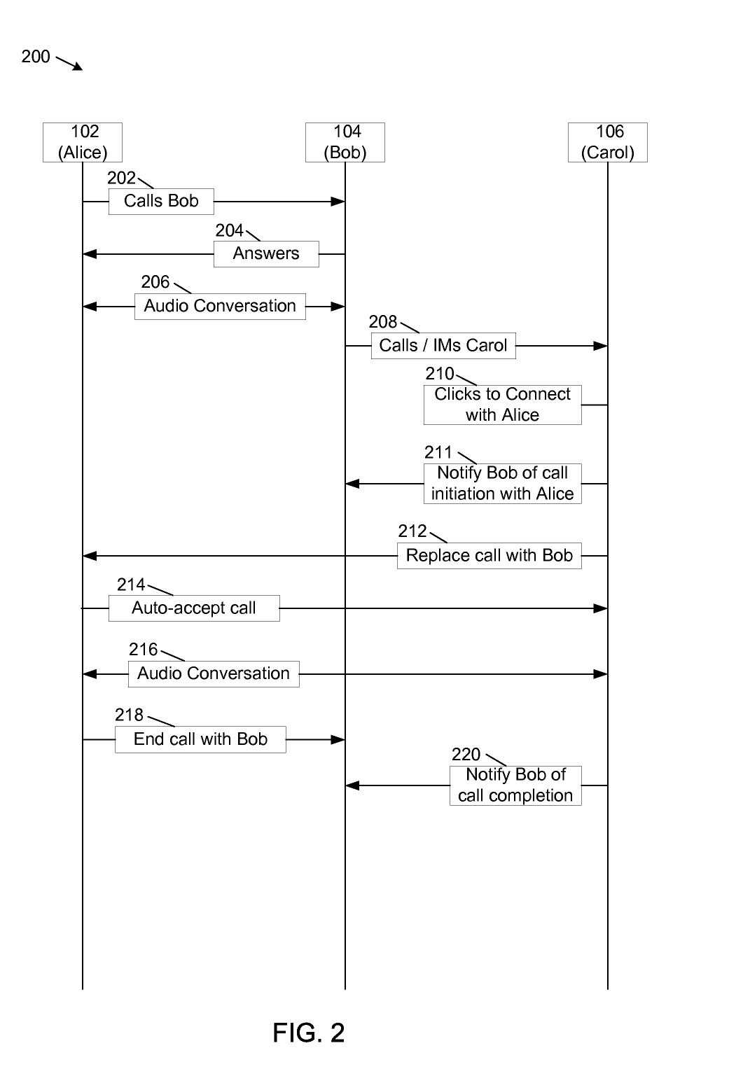

FIG. 2 shows example action flow 200 for a consultation call using the system of FIG. 1. In the example, Alice is a user on client computer 102, Bob is a user on client computer 104 and Carol is a user on client computer 106. Each client computer 102, 104, 106 is connected via Intranet network 108 to communication server 110. In other examples, Alice, Bob or Carol may be a user on another communication server (not shown) connected to Intranet network 108 or connected to another corporate Intranet (not shown) via network 112.

In the example of FIG. 2, Alice at client computer 102 calls Bob (action 202) at client computer 104. In this example, Bob is an assistant of Carol at client computer 106. In this example, Bob is a delegate and Carol is a boss. Bob answers the call from Alice (action 204) and an audio conversation (action 206) is established between Bob and Alice. In the audio conversation, Bob learns that Alice would like to speak with Carol. Bob also learns the reason for the call and any other additional information pertinent to the call.

Because client 102 and client 104 both support VOIP, the call from Bob to Carol is established using a communication protocol that is supported by VOIP, for example SIP. In action 202, when Alice calls Bob, client computer 102 sends a SIP Invite message to client computer 104. The SIP Invite message includes an ID that identifies Bob. When Alice answers her telephone (action 204) additional SIP messages are transmitted between client computer 102 and client computer 104. These messages include a 200 OK message from client computer 104 to client computer 102 and an ACK message from client computer 102 to client computer 104. This results in a voice connection being established between client computer 102 and client computer 104 and permits Alice and Bob begin an audio conversation (action 206).

When Bob learns that Alice would like to speak with Carol, Bob sends a communication to Carol (action 208) informing Carol that Alice would like to speak with her. The communication is typically a voice communication (in which Bob calls Carol) or an instant message in which Bob provides information about the call from Alice. The voice communication is a consultation call in which Bob consults with Carol, and Carol makes a determination whether to accept the call.

Because Bob is Carol's delegate, Bob typically has access to Carol's personal schedule. If Bob knows that Carol is in a meeting, for example, Bob may send Carol an instant message rather call Carol on the telephone. As another example, Bob may send Carol an instant message based on Carol having a presence status of busy or in a meeting.

When Bob calls Carol (action 208), a SIP Invite message is sent from client computer 104 to client computer 106. The SIP Invite message is used during a consultation call to inform client 106 of a possible transfer operation. The SIP Invite message includes signaling information derived from the call between Alice and Bob and includes an ID for Alice. The signaling information may include the time of the call from Alice to Bob, the location from which Alice initiated the call to Bob, etc. The signaling information may also other information, including metadata relating to Alice, such as Alice's name and job title. The signaling information may also include contextual information, such as information relevant to the social relationship between Alice and Carol, notes that Bob may have taken during the call with Alice, information about Alice's availability, etc. The signaling information is formatted and displayed on a user interface of client computer 106 so Carol can easily see it and use it.

When Bob sends an instant message to Carol (action 208), a SIP Invite message is sent from client computer 104 to client computer 106. In the instant message, Bob may include the reason for the call and any other pertinent information related to the call. For example, Bob may include information about Alice's appointment schedule, such as the next scheduled appointment between Carol and Alice. The instant message may also other information, including metadata relating to Alice, such as Alice's name and job title. The instant message may also include contextual information, such as information relevant to the social relationship between Alice and Carol, notes that Bob may have taken during the call with Alice, etc. The instant messaging information is formatted and displayed on the user interface of client computer 106 so Carol can easily see it and use it.

The signaling and instant message information may be included in a payload of the SIP Invite message sent during action 208, or it may be part of the header of the SIP Invite message. One type of payload formats the signaling and instant message information according to the Session Description Protocol (SDP). Another type of payload formats the signaling and instant message information using XML. For example, the signaling and instant message information can be included in an XML blob in the payload. Other payload types are possible.

When Bob calls Carol or sends an instant message to Carol, a user interface at client computer 106 shows that Bob is calling and also displays any information available about the call between Bob and Alice. If Bob sends Carol an instant message, the contents of the instant message are displayed on the user interface of client computer 106. From the information displayed on the user interface and from any additional information Carol obtains from Bob, Carol determines whether to accept the telephone call from Alice.

When Carol decides to accept the telephone call from Alice, Carol clicks a button on the user interface of client computer (action 210) to connect with Alice. The button is typically labeled “Connect,” but the button can be any similarly named button on the user interface. Alternately, Carol may click on a link representing “Connect.” Carol's action of clicking on a button or a link representing “Connect” initiates a process that results in the call between Alice and Bob being transferred to Carol. This process does not require any additional action from Bob. Therefore, Carol is able to transfer the call from Bob to herself directly.

When Carol presses the Connect button or clicks on the Connect link, client computer 106 sends a SIP Notify message to client computer 104 (action 211). The SIP Notify message informs client computer 104 of the initiation of a telephone call between Carol at client computer 106 and Alice at client computer 102. In addition, a SIP Invite with Replaces message is sent from client computer 106 to client computer 102 (action 212). The SIP Invite with Replaces message is an SIP Invite message that includes “Replaces” in the message header. The SIP Invite with Replaces message sent in action 212 indicates that client computer 104 (Bob) is to be replaced with client computer 106 (Carol) in the original call between client computer 102 (Alice) and client computer 104 (Bob).

When client computer 102 receives the Invite message from action 212, client computer 102 auto accepts (action 214) and establishes a connection between client computer 102 (Alice) and client computer 106 (Carol). An audio conversation then starts between Alice and Carol (action 216). The auto accept occurs because the Invite with Replaces message includes IDs for both Alice and Carol and permits the connection between client computer 102 and client computer 106 to be made. In addition, when client computer 102 auto accepts (action 214), client computer 102 sends a SIP Bye message to client computer 104 to terminate the call between Alice at client 102 computer and Bob at client computer 104 (action 218). When client computer 106 receives the audio accept (action 214), client computer 106 sends a SIP Notify message to client computer 104 (action 220), informing client 104 that Carol has replaced Bob in the telephone call with Alice.

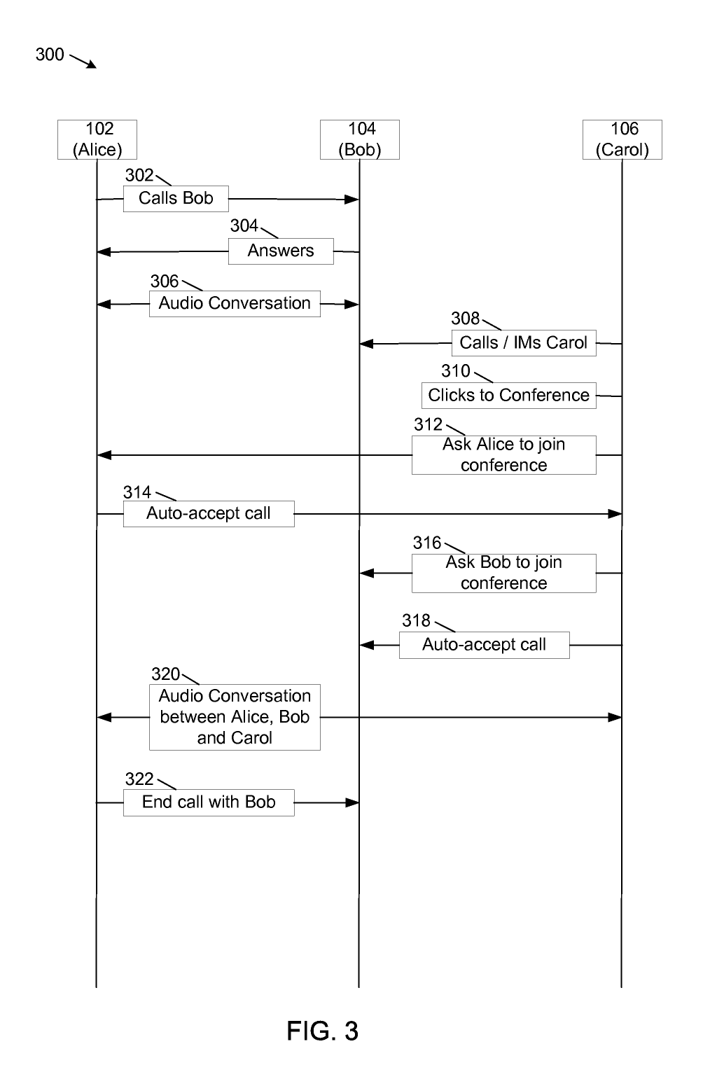

FIG. 3 shows an example action flow 300 for another example consultation call using the system of FIG. 1. In the example action flow 300, actions 302 through 308 are the same as actions 202 through 208, respectively, of action flow 200 from FIG. 2.

However, in this example, Carol decides to conference Bob with Alice rather than simply transferring the call from Bob to Carol. To establish a conference call with Alice and Bob, Carol clicks a Conference button on the user interface of client computer (action 310). The button is typically labeled “Conference,” but the button can be any similarly named button on the user interface. Alternately, Carol may click on a link representing “Conference.”

When Carol presses the Conference button or clicks on the Conference link, client computer 106 sends a SIP Invite with Replaces message to client computer 102 inviting Alice to join a conference with Carol (action 312). The SIP Invite with Replaces message includes a Replaces header which notifies client computer 102 to replace the call between Alice and Bob with a conference call between Alice, Carol and Bob. When client computer 102 receives the SIP Invite message with the Replaces header, client computer 102 auto accepts (action 314) and replaces the call between Alice and Bob with the conference call between Alice, Carol and Bob. In addition, when Carol presses the Conference button or clicks on the Conference link, client computer 106 sends a SIP Invite with Replaces message to client 104 inviting Bob to join a conference with Carol (action 316). The SIP Invite with Replaces message sent to client 104 as part of action 316 includes a Replaces header which notifies client computer 104 to replace the telephone call between Bob and Alice with the conference call between Alice, Carol and Bob. When client computer 104 receives the SIP Invite with Replaces message from client computer 106, client computer 104 auto accepts (action 318) and replaces the telephone call between Bob and Alice with the conference call between Alice, Carol and Bob.

At this point a conference call is established and an audio conversation can begin between Alice, Carol and Bob (action 320). Once the conference call is established, the initial telephone call between Alice and Bob is terminated (action 322). In addition, if an instant message was sent between Bob and Carol (action 308) instead of a consultation call, the instant messaging session is ended when client computer 106 auto accepts (at action 318).

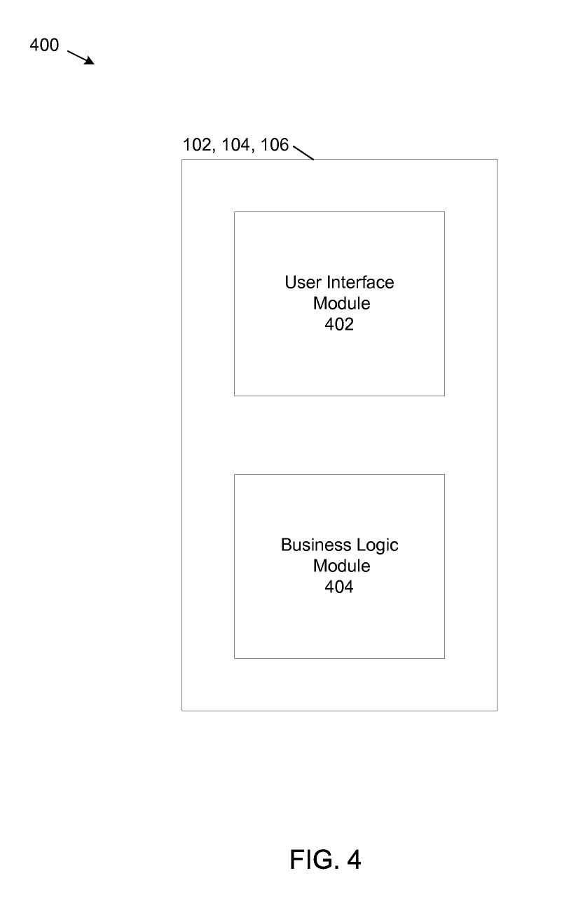

FIG. 4 shows example modules of client computers 102, 104, 106. The example modules include user interface module 402 and business logic module 404. The user interface module 402 provides a user interface for the VOIP software program installed on client computers 102, 104, 106. The user interface provides a display area that provides status to a user and a controls area that permits the user to initiate actions such as making a phone call, sending an instant message, transferring a phone call and joining a conference call. The user interface also includes a control that permits the user to initiate the transfer of a call to the user as a result of a consultation call.

The example business logic module 404 provides the functionality for managing calls received and transmitted at client computers 102, 104, 106 and for providing additional services such as call transfer, conferencing and instant messaging. When a user, for example a user at client computer 106, initiates the transfer of a telephone call to the user as a result of a consultation call, the business logic module 404 processes SIP messages sent from client computer 106 and received at client computer 106 that facilitate the call transfer. The SIP messages include a SIP Invite with Replaces message sent from client computer 106. The business logic module 404 also processes signaling information included in a telephone call or instant message and provides the signaling information to the user interface module 402 for display on the user interface of the client computer that receives the signaling information, for example client computer 106.

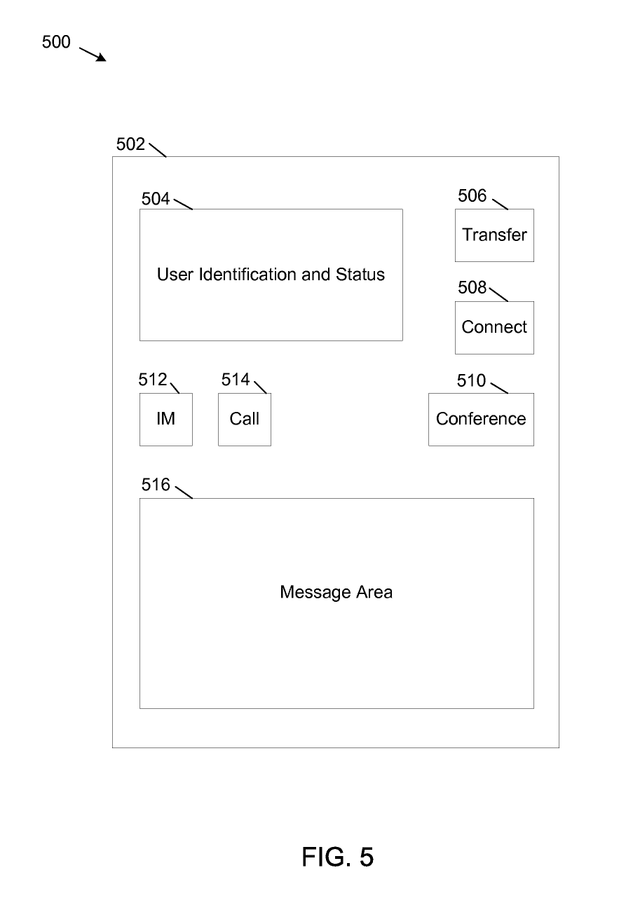

FIG. 5 shows an example user interface 500 for client computers 102, 104, 106 that is generated by the user interface module 402. The user interface 500 includes an example user identification and status area 504. The user identification and status area 504 identifies a user at the client computer, for example Alice, and provides information about the user, such as job title, whether the user is currently in a call or currently in an instant messaging session, etc.

The user interface 500 also includes example buttons to activate communication functions. Example function buttons include transfer button 506, connect button 508, conference button 510, IM button 512 and call button 514. The transfer button 506 is used to initiate a call transfer (for example from Bob to Carol). The connect button 508 is used to initiate a connection to a party during a consultation call, thereby completing a call transfer operation. The conference button 510 is used to start a conference call. The IM button 512 is used to initiate an instant messaging session and the example call button 514 is used to initiate a telephone call. In addition the message area 516 is used to display signaling information and information from instant messages. For example, the message area 516 can display the reason for a telephone call and other information related to the subject matter of telephone call, such as possible appointment dates and times that Alice has available for a meeting with Carol. The information displayed on user interface 500 can be helpful for a user, for example Carol, to determine whether to accept a telephone call with another user, for example Alice. Other buttons and additional functionality for the described buttons and display areas are possible.

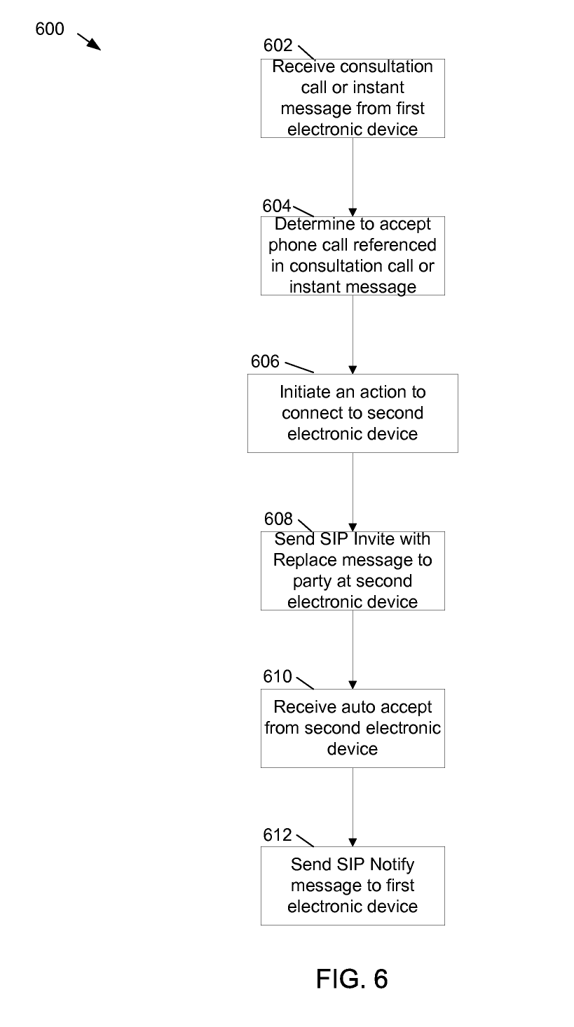

FIG. 6 shows an example flowchart of a method 600 for using a consultation call or instant message to directly transfer a telephone call. At operation 602, Carol, at client computer 106 receives a communication from Bob at client computer 104. The communication is either a consultation telephone call or an instant message. In this example, Carol is Bob's boss and Bob is Carol's assistant or delegate. If the communication is a consultation telephone call, Bob explains to Carol that Bob has received a telephone call from Alice and that Alice would like to speak directly with Carol. Bob also discloses to Carol other information relating to the telephone call that Alice may have conveyed to Bob, such as the purpose of the call and any specific information that Alice needs from Carol. In addition, signaling information relating to the telephone call from Alice to Bob and the consultation telephone call from Bob to Alice is displayed on a user interface of client 106. Examples of signaling information are the time of each call, the identity of each caller, the job description of each caller, etc.

If the communication is an instant message, the instant message is displayed on the user interface of client 106. In the instant message, Bob may have included information about the telephone call from Alice, such as the purpose of the telephone call and any specific information that Alice requires from Carol. In addition, signaling information is displayed on the user interface of client 106, including such items as the time of the call from Alice to Bob, information about Alice, etc. Bob may have sent Carol an instant message instead of calling Carol for a variety of reasons, for example Carol being in a meeting.

At operation 604, Carol evaluates the information obtained from the consultation telephone call or the instant message and determines whether to accept the call from Alice. When Carol determines to accept the call from Alice, at operation 606 Carol initiates an action at client computer to connect to Alice. Typically, the action Carol takes is to press a button on the user interface of client computer 106 that represents connect, such as a Connect button. Carol takes the action to connect to Alice without any additional action from Bob. Therefore, Carol is in control of making the connection to Alice.

As result of operation 606, at operation 608, client computer 106 sends a SIP Invite with Replaces message to client computer 102 to request a connection with Alice. The SIP Invite with Replaces message includes a Replaces header in the message that includes an identifier for Alice at client computer 102. The Replaces header in the message indicates to client computer 102 that the call between Alice and Bob is to be replaced with a call between Alice and Carol. The SIP Invite with Replaces message includes the required signaling information for client computer 102 to auto accept the connection request from Carol. Consequently, client computer 102 accepts the connection request and at operation 610 client computer 106 receives an auto accept, typically an SIP 200 OK message, from client computer 102. A voice connection is thereby established between Alice and Carol. At operation 612, client computer 106 sends a SIP Notify message to client computer 104 to inform client computer 104 that Carol has replaced Bob in the telephone call with Alice.

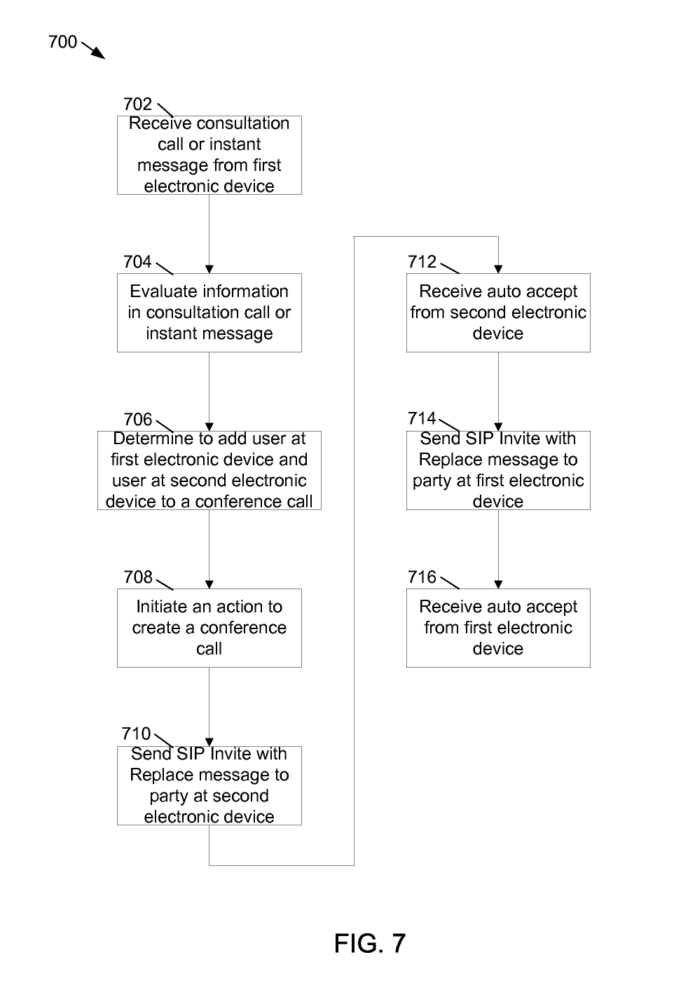

FIG. 7 shows an example flowchart of a method 700 for using a consultation call or instant message to directly initiate a conference call. At operation 702, Carol at client computer 106 receives a communication from Bob at client computer 104. The communication is either a consultation telephone call or an instant message. If the communication is a consultation telephone call, Bob explains to Carol that Bob has received a telephone call from Alice and that Alice would like to speak directly with Carol. Bob also discloses to Carol other information relating to the telephone call that Alice conveyed to Bob, such as the purpose of the call and any specific information that Alice needs from Carol. In addition, signaling information relating to the telephone call from Alice to Bob and the consultation telephone call from Bob to Alice is displayed on a user interface of client 106. Examples of signaling information are the time of each call, the identity of each caller, the job description of each caller, etc.

If the communication is an instant message, the instant message is displayed on the user interface of client 106. In the instant message, Bob may have included information about the telephone call from Alice, such as the purpose of the telephone call and any specific information that Alice requires from Carol. In addition, signaling information is displayed on the user interface of client 106, including such items as the time of the call from Alice to Bob, information about Alice, etc. Bob may have send Carol an instant message instead of calling Carol for a variety of reasons, for example Carol being in a meeting.

At operation 704, Carol evaluates the information obtained from the consultation call or the instant message and determines whether to accept the call from Alice. In addition, Carol may determine that Bob should also be included on the call. For example, Carol may want Bob to take notes or to follow up on certain items discussed in the call. Therefore, Carol may want Bob to be included in a conference call with Alice and Carol.

At operation 706, Carol determines to accept the call from Alice and to create a conference call between Alice, Carol and Bob. At operation 708 Carol initiates an action at client computer to create a conference call between Alice, Carol and Bob. Typically, the action Carol takes is to press a button on the user interface of client computer 106 that represents a conference call, such as a Conference button. Carol takes the action to create the conference call without any additional action from Bob. Therefore, Carol is in control of creating the conference call between Carol, Alice and Bob.

As result of operation 708, at operation 710 client computer 106 sends a SIP Invite with Replaces message to client computer 102 to request a connection with Alice. The SIP Invite with Replaces message includes a Replaces header in the message that includes an identifier for Alice at client computer 102. The Replaces header in the message indicates to client computer 102 that the call between Alice and Bob is to be replaced with a call between Alice and Carol. The SIP Invite with Replaces message includes the required signaling information for client computer 102 to auto accept the connection request from Alice. Consequently, client computer 102 accepts the connection request and at operation 712 client computer 106 receives an auto accept, typically an SIP 200 OK message, from client computer 102.

In addition, as a result of operation 708, if the communication in operation 702 is a consultation telephone call, at operation 714 client computer 106 sends a SIP Invite with Replaces message to client computer 104 to replace the connection between Bob and Carol with a conference call connection. The SIP Invite with Replaces message includes a Replaces header in the message that includes an identifier for Bob at client computer 104. The Replaces header in the message indicates to client computer 104 that the call between Bob and Carol is to be replaced with a conference call between Alice, Bob and Carol. The SIP Invite with Replaces message includes the required signaling information for client computer 104 to auto accept the conference call request from Alice. Consequently, client computer 104 accepts the connection request and at operation 716 client computer 106 receives an auto accept, typically an SIP 200 OK message, from client computer 104. At this point a conference call is established between Alice, Carol and Bob.

If the communication in operation 702 is an instant message from Bob, at operation 714 client computer 106 also sends a SIP Invite with Replaces message to client computer 104. The SIP Invite with Replaces message includes a Replaces header in the message that includes an identifier for Bob at client computer 104. The Replaces header in the message indicates to client computer 104 that the instant message between Bob and Carol is to be replaced with a conference call between Alice, Bob and Carol. At operation 716, client computer 106 receives an auto accept from client computer 104 and a conference call is established between Alice, Bob and Carol. In examples, operation 714, sending an SIP Invite with Replaces message to a party at the first electronic device may occur before operation 710, sending an SIP Invite with Replaces message to a party at the second electronic device.

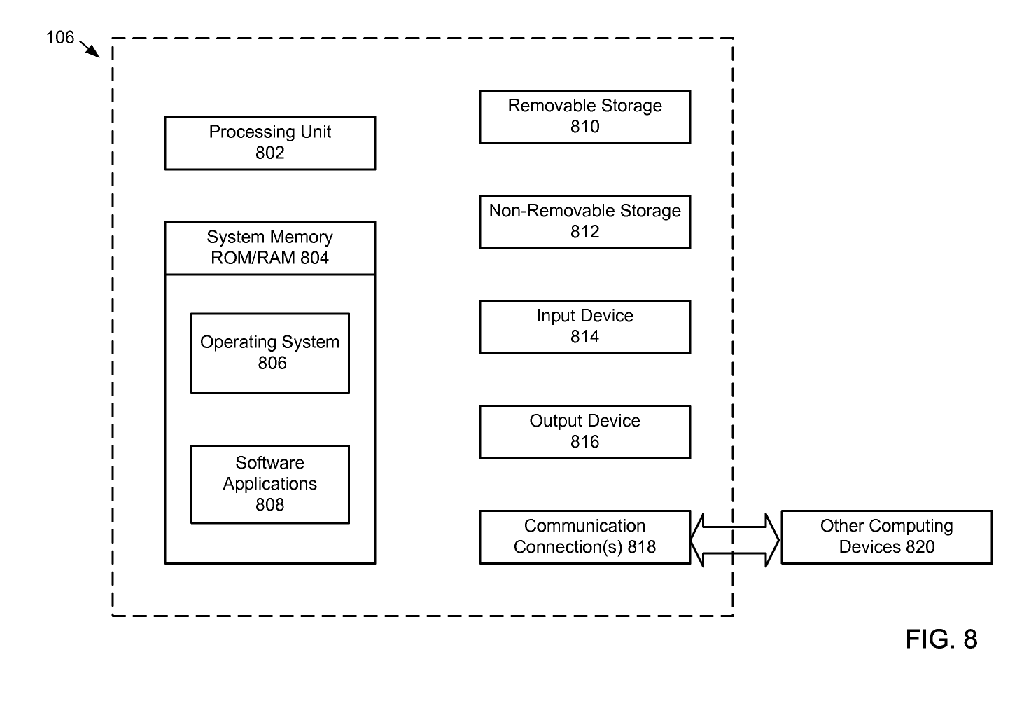

With reference to FIG. 8, example components of client computer 106 are shown. In example embodiments, the client computer is a computing device. The computing device 106 can include input/output devices, a central processing unit (“CPU”), a data storage device, and a network device.

In a basic configuration, the client computer 106 typically includes at least one processing unit 802 and system memory 804. Depending on the exact configuration and type of computing device, the system memory 804 may be volatile (such as RAM), non-volatile (such as ROM, flash memory, etc.) or some combination of the two. System memory 804 typically includes an operating system 806 suitable for controlling the operation of a networked personal computer, such as the WINDOWS® operating systems from Microsoft Corporation of Redmond, Wash. or a server, such as Windows SharePoint Server 2007, also from Microsoft Corporation of Redmond, Wash. The system memory 804 may also include one or more software applications 808 and may include program data.

The client computer 106 may have additional features or functionality. For example, the client computer 106 may also include computer readable media. Computer readable media can include both computer readable storage media and communication media.

Computer readable storage media is physical media, such as data storage devices (removable and/or non-removable) including magnetic disks, optical disks, or tape. Such additional storage is illustrated in FIG. 8 by removable storage 810 and non-removable storage 812. Computer readable storage media may include volatile and nonvolatile, removable and non-removable media implemented in any method or technology for storage of information, such as computer readable instructions, data structures, program modules, or other data. Computer readable storage media can include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client computer 106. Any such computer readable storage media may be part of device 106. Client computer 106 may also have input device(s) 814 such as keyboard, mouse, pen, voice input device, touch input device, etc. Output device(s) 816 such as a display, speakers, printer, etc. may also be included.

The client computer 106 may also contain communication connections 818 that allow the device to communicate with other computing devices 820, such as over a network in a distributed computing environment, for example, an intranet or the Internet. Communication connection 818 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The various embodiments described above are provided by way of illustration only and should not be construed to limiting. Various modifications and changes that may be made to the embodiments described above without departing from the true spirit and scope of the disclosure.

What is claimed is:

1. A method for transferring a telephone call, the method comprising:
receiving a communication at a first client computer from a second client computer, the first client computer and the second client computer running communication software that supports voice over Internet Protocol, the communication including information associated with a telephone call received at the second client computer, the information including a request to transfer the telephone call to the first client computer;
after receiving the communication from the second client computer at the first client computer, determining whether to accept the telephone call;
when a determination is made to accept the telephone call, initiating an action at the first client computer that causes the telephone call to be transferred to the first client computer, the action resulting in replacing the second client computer with the first client computer as a party in the telephone call.

2. The method of claim 1, wherein the communication is a telephone call.

3. The method of claim 1, wherein the communication is an instant message.

4. The method of claim 3, wherein an instant messaging session between the first client computer and the second client computer is terminated when the second client computer is replaced with the first client computer as a party in the telephone call.

5. The method of claim of claim 3, wherein the instant message includes first information relating to the purpose of the telephone call and also includes second information relating to a caller who initiated the telephone call received at the second client computer, the first information and the second information being displayed on a user interface of the first client computer.

6. The method of claim 1, wherein the communication includes information relating to the telephone call and the caller, the information being displayed on a user interface of the first client computer.

7. The method of claim 6, wherein the communication identifies a caller who initiated the telephone call received at the second client computer and also includes information about the purpose of the telephone call.

8. The method of claim 6, wherein the communication includes metadata and contextual information about the caller.

9. The method of claim 1, wherein replacing the second client computer with the first client computer as a party in the telephone call further comprises receiving a Session Initiation Protocol Invite message at the first client computer from the second client computer, the Session Initiation Protocol Invite message including a parameter that indicates that the second client computer is to be replaced with the first client computer as a party in the telephone call.

10. The method of claim 1, wherein the action that causes the telephone call to be transferred to the first client computer is initiated via a user interface at the first client computer.

11. The method of claim 10, further comprising sending a Session Initiation Protocol Invite message from the first client computer to the second client computer as a result of an action taken at the user interface at the first client computer.

12. The method of claim 1, further comprising adding the second client computer as a party in the telephone call, the telephone call becoming a conference call when the second client computer is added as a party in the telephone call.

13. The method of claim 12, wherein adding the second client computer as a party in the telephone call is initiated via a user interface at the first client computer.

14. A first electronic computing device that is configured to run a communications application, the first electronic computing device comprising:
a processing unit;
a computer readable storage medium encoding instructions that, when executed by the processing unit, cause the processing unit to create:
a user interface module that controls a user interface at the first electronic device; and
a business logic module implementing communication functions for the communications application, the communication functions including processing signaling information received as part of a communication from a second electronic computing device, the signaling information including information about a telephone call received at the second electronic computing device, the business logic module permitting a user at the first electronic computing device to replace the second electronic computing device with the first electronic computing device in the telephone call.

15. The first electronic computing device of claim 14, wherein the signaling information includes the identity of a caller connected in a telephone call with the second client computer, the signaling information includes a request to transfer the telephone call from the second client computer to the first client computer, the signaling information includes the purpose of the telephone call and the signaling information includes additional information about the caller.

16. The first electronic computing device of claim 14, wherein the processed signaling information is displayed on the user interface.

17. The first electronic computing device of claim 14, wherein the user interface includes a control that permits the user at the first electronic computing device to replace the second electronic computing device with the first electronic computing device in the telephone call.

18. The first electronic computing device of claim 14, wherein the user interface includes a control that permits the user at the first electronic device to add a party in the telephone call to a conference call.

19. The first electronic computing device of claim 14, wherein the information about a telephone call received at the second electronic computing device further comprises first information relating to a caller who initiated the telephone call at the second electronic computing device and second information related to the subject matter of the telephone call, the first information and the second information being displayed on the user interface.

20. A computer readable storage medium comprising instructions that, when executed by a processing unit of a first electronic device, cause the processing unit to:
receive an instant message at a first client computer from a second client computer, the first client computer and the second client computer running communication software that supports voice over IP, the instant message including information associated with a telephone call received at the second client computer, the information identifying a caller that initiated the telephone call, the information including the purpose of the telephone call, the information including a request to transfer the telephone call to the first client computer, at least part of the information being signaling information automatically derived from the telephone call, the signaling information including the identify of the caller that initiated the telephone call and the time and date of the telephone call;
at the first client computer, after receiving the instant message from the second client computer, determine whether to accept the telephone call;
when a determination is made to accept the telephone call, initiating an action at the first client computer that causes the telephone call to be transferred to the first client computer, the action being pressing a button or clicking on a link at a user interface at the first client computer, the action resulting in the replacement of the second client computer with the first client computer as a party in the telephone call, the transferring of the telephone call to the first client computer comprising sending a Session Initiation Protocol Invite message from the first client computer to the second client computer, the Session Initiation Protocol Invite message including a Replaces header that indicates that the second client computer is to be replaced with the first client computer as a party in the telephone call.
